(19) United States
(12) Patent Application Publication
(10) Pub. No.: US 2007/0006974 A1
(43) Pub. Date: Jan. 11, 2007

(54) Tape applicator

(76) Inventor: George P. Gruber, Hopkins, MN (US)

Correspondence Address: Leffert Jay & Polglaze, P.A., P.O. Box 581009, Minneapolis, MN, 55458-1009, US

(21) Appl. No.: 11/176,086

(22) Filed: Jul. 7, 2005

(51) Int. Cl. B44C 7/00; B32B 37/00

(52) U.S. Cl. 156/577; 156/579; 156/535

(57) ABSTRACT

The housing has a spindle that accepts a spool of a roll of tape. The spindle has retention fingers that can either exert pressure against the spool or the retention fingers can connect with a detent on the inner surface of the spool. Biasing alignment fingers are built into the housing to exert a spring pressure against the roll of tape in a direction that is substantially parallel to the spindle to aid in registering an edge of the roll of tape with an outer edge of the housing. A base surface of the device has an opening through which an end of the roll of tape exits. The tape rides over a fixed or movable wear surface adjacent to the opening. A cutting edge is substantially adjacent to and pointing away from the opening.

### TECHNICAL FIELD OF THE INVENTION

The present invention relates generally to tape applicators.

### BACKGROUND OF THE INVENTION

There exist multiple types of tape each having multiple uses. For example, painters may use masking tape for, among other tasks, masking certain areas that are not desired to be painted.

Placing tape on a surface to act as a mask for paint typically requires precise placement over the area or border to be masked. This can require a relatively large amount of time on the part of the painter in order to achieve the desired accuracy. This conflicts with the need for the painter to reduce the time required for each job since they can increase their income potential by completing more jobs in a given amount of time.

For the reasons stated above, and for other reasons stated below which will become apparent to those skilled in the art upon reading and understanding the present specification, there is a need in the art for a tape applicator that accurately applies tape.

### SUMMARY

The present invention encompasses a tape applicator device comprising a spindle that is adapted to accept an inner surface of a roll of tape. Biasing alignment fingers are built into the housing of the device to exert a pressure against the roll of tape in a direction that is substantially parallel to the spindle. A base surface of the device has an opening through which an end of the roll of tape can be inserted. The tape rides over a wear surface adjacent to the opening. The wear surface can be fixed or a rotating surface that moves with pressure on the base surface. A cutting edge is substantially adjacent to and pointing away from the opening.

### BRIEF DESCRIPTION OF THE DRAWINGS

FIG. 1 shows a front perspective view of one embodiment of a tape applicator of the present invention.

FIG. 2 shows a rear perspective view of the embodiment of FIG. 1.

FIG. 3 shows a rear perspective view of a tape system of the present invention.

FIG. 4 shows a front perspective view of an alternate embodiment of the tape applicator of the present invention.

FIG. 5 shows a front perspective view of another alternate embodiment of the tape applicator of the present invention.

FIG. 6 shows a perspective view of a roll of tape in accordance with one embodiment of the tape applicator of the present invention.

### DETAILED DESCRIPTION

The tape applicator of the present invention provides a tape user with the ability to quickly apply an accurate line of tape along a surface. This is accomplished with minimal time required for keeping the tape aligned along the desired border.

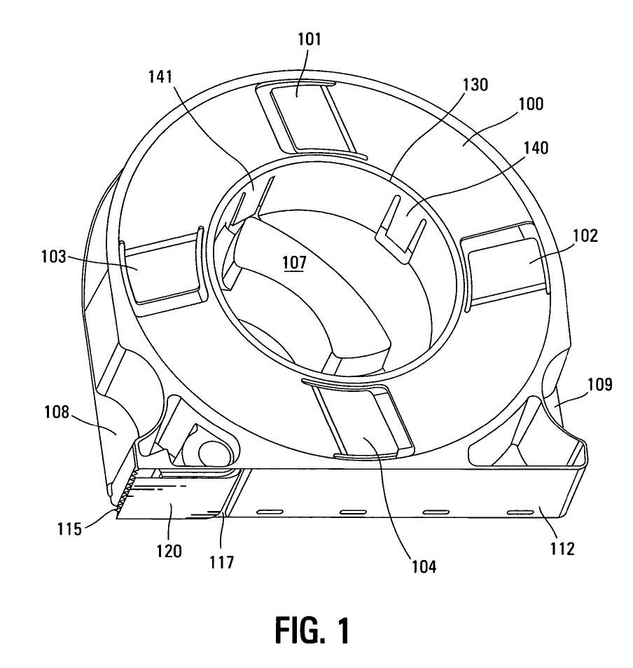

FIG. 1 illustrates one embodiment of the tape applicator of the present invention. The applicator is comprised of a tape housing 100 in which the tape is held. The tape housing in the illustrated embodiment has a circular appearance. However, there is no requirement that this element have any certain shape. Any housing shape that is large enough to fit a circular roll of tape will operate properly.

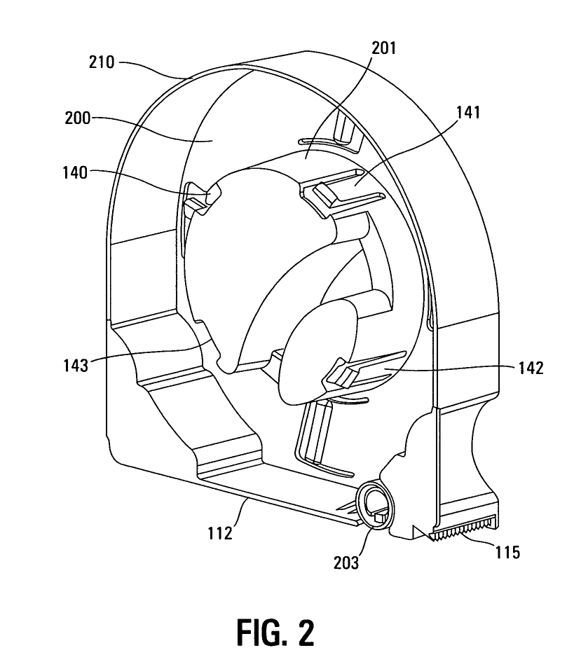

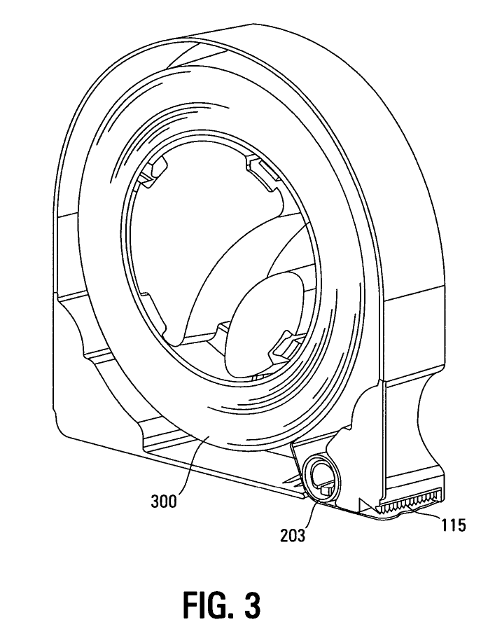

A central spindle element 130 holds the roll of tape, as is illustrated subsequently in FIG. 3. The central spindle 130, in one embodiment, includes a plurality of retention fingers 140, 141 that provide a friction fit against the tape roll to help hold it in place. The present embodiment of FIGS. 1 and 2 show four retention fingers 140-143. Alternate embodiments can use other quantities of the retention fingers 140-143 than what is shown.

Biasing alignment fingers 101-104 are formed into the surface of the housing 100. Alternate embodiments can include different quantities of biasing alignment fingers 101-104. In one embodiment, the fingers 101-104 are comprised of depressed areas in the surface of the housing that provide an active spring pressure onto the tape roll. The biasing alignment fingers 101-104, in co-operation with the pressure of retention fingers 140-143, to accommodate variations and inconsistencies in tape windings.

Tape, when wound to make a roll of tape, is not perfect and can vary in width depending on the accuracy of the windings. The biasing alignment fingers 101-104 provide compensation for this inaccuracy in order to apply the tape accurately to the surface. The pressure of the retention fingers 140-143 are responsible for pulling the roll of tape in to keep it in contact with the biasing alignment fingers 101-104.

A handle 107 is formed within the depression formed in the central spindle 130. This handle 107 may be formed such that a user's thumb and fingers can fit inside the spindle depression and grasp the handle 107.

In one embodiment, two depressions 108, 109 are provided as another means to grip the applicator. The illustrated embodiment uses semicircular depressions 108, 109. Alternate embodiments may use other shapes or not include the depressions 108, 109.

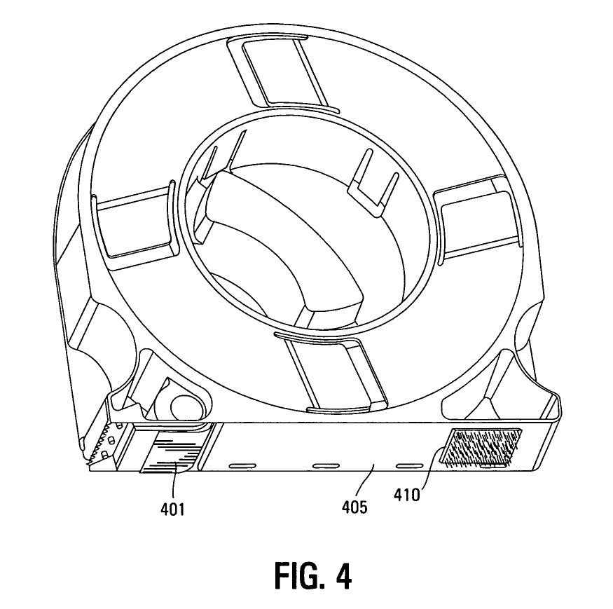

The tape exits the applicator through a mouth 117. As is shown subsequently with reference to FIGS. 2 and 4, the mouth may contain a movable wear surface or a fixed wear surface. The tape rides along a flat surface 120 prior to the cutting edge 115 that is used to cut the tape to the desired length. The applicator further has flat base 112 that, in one embodiment, rides along the surface to which the tape is being applied.

In operation, an outer edge 210 (see FIG. 2) of the applicator is addressed to a wall or other registration surface at the same time that the flat base 112 of the applicator is addressed to the surface to which the tape is to be applied. The biasing alignment fingers 101-104 work together with the retention fingers 140-143 to maintain alignment of tape rolls having variations in width. As discussed previously, the biasing alignment fingers 101-104 maintains a spring pressure outward while the retention fingers pull the tape roll in to maintain contact with the biasing alignment fingers 101-104.

The tape exits the mouth 117 as it is being drawn off the tape roll and rides along the flat applicator surface 120. The tape is applied with an outer edge thereof in substantial registration with the outer edge 210 of the applicator. When the user reaches the end of the surface being masked, the base 112 is lifted slightly from the taped surface and angled such that the cutting edge 115 can be applied to the tape.

FIG. 2 illustrates a rear perspective view of the embodiment of FIG. 1. This view shows the housing area 200 in which the roll of tape can be mounted and the outer edge 210 of the housing to which the outer surface of the tape is aligned. The outer surface 201 of the central spindle 130 of FIG. 1 accepts the inner surface of the roll of tape. The retention fingers 140-143 may include gripping detents at the ends of the fingers 140-143 to provide additional pressure against the inner portion of the tape roll. Alternate embodiments may use only the ends of the fingers 140-143 without the detents to keep pressure on the tape roll.

This view of the present invention also shows the embodiment of the movable wear surface in the form of a cylindrical roller 203 at the mouth of the applicator. As the applicator is drawn along the surface over which tape is attached, pressure is placed on the base surface 112 and the roller 203. This moving pressure causes the roller 203 to turn at the same rate as the movement, thus assisting in keeping the tape moving as it exits the applicator towards the cutting edge 115.

FIG. 3 illustrates a tape system of the present invention. This view is the rear perspective view of FIG. 2 including a roll of tape 300. The end of the tape is pulled out of the mouth of the device and over the roller 203, or other wear surface, towards the cutting edge 115.

FIG. 4 illustrates a front perspective view of an alternate embodiment of the tape applicator of the present invention. This embodiment is substantially similar to the embodiment of FIG. 1 but illustrates the replacement of the roller 203 at the mouth of the applicator with a fixed wear surface 401. This surface 401, in one embodiment, is built into the housing. The tape rides over the surface 401, as it exits the device, due to pressure applied to the base surface.

This embodiment also shows an optional brush 410 that removes foreign matter from the surface to which the tape is about to be applied. The brush is for purposes of illustration only. Alternate embodiments can use other forms of surface cleaning such as a cleaning pad that can be abrasive or a non-abrasive pad containing a cleaning solution, such as alcohol, that dries rapidly. The brush or other cleaning element 410 may be fixed in place or removable/replaceable by the user, depending on the application. Additionally, the cleaning element 410 can be located along the entire length of the base 405, in only one position as shown, or in multiple locations. In yet another embodiment, the brush 410 can be placed such that it burnishes the tape on the application surface.

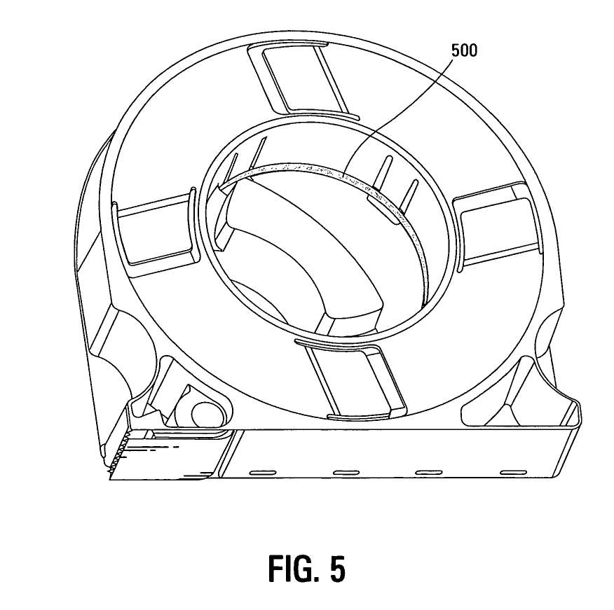

FIG. 5 illustrates an alternate embodiment of the tape applicator of the present invention. This embodiment uses a metal band 500 internal to the spindle to apply a force against the plurality of retention fingers. The metal band has a memory attribute that allows it to expand while the tape roll is removed from the applicator and yet apply the same force against the retention fingers when the tape roll is installed. This embodiment permits the use of a less expensive plastic that has less of a memory attribute.

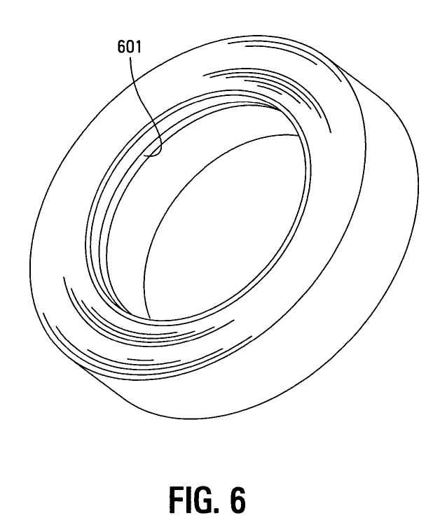

FIG. 6 illustrates one embodiment for a roll of tape to be used in a tape system of the present invention. In this embodiment, the tape has a groove 601 formed on the inside surface of the tape spool. The groove 601 encircles the inside perimeter of the spool and is used as a detent into which the retention fingers 140-143 of the above-described embodiments fit. When the tape is inserted into the applicator, the ends of the retention fingers 140-143 seat into the groove to hold the roll of tape firmly in the applicator.

The groove 601 is not limited to any one shape. For example, it may have a rounded bottom so that any type of retention finger can fit. Or the groove 601 can have the same shape as the ends of the retention fingers so that the fingers make a snug fit. In an alternate embodiment, the groove is broken up into a plurality of detents that are formed only in predetermined locations within the spool that substantially match up with the orientation of the retention fingers.

### CONCLUSION

In summary, the tape applicator of the present invention provides an accurate means for applying tape along a surface. The applicator can be comprised of plastic, metal, or some other material.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A tape applicator device comprising:
a spindle adapted to accept a roll of tape;
biasing alignment fingers built into the device that exert a pressure against the roll of tape in a direction parallel to the spindle; and
a base surface comprising an opening through which an end of the roll of tape can be inserted.

2. The device of claim 1 wherein the spindle fits inside the roll of tape.

3. The device of claim 1 wherein the spindle comprises:
a plurality of retention fingers that are adapted to provide pressure against an inner portion of the roll of tape to keep the roll of tape against the biasing alignment fingers.

4. The device of claim 1 wherein the spindle comprises:
a handle formed within the spindle.

5. The device of claim 1 wherein the pressure from the biasing alignment fingers is such that and edge of the roll of tape is substantially registered with an outer edge of the device.

6. The device of claim 3 wherein the plurality of retention fingers are substantially equally spaced around the periphery of the spindle.

7. The device of claim 1 wherein the biasing alignment fingers are substantially equally spaced in a circular pattern around the device.

8. A tape applicator device comprising:
a spindle adapted to accept a roll of tape, the spindle comprising a plurality of retention fingers substantially equally spaced around the outer periphery of the spindle such that they apply pressure to the inner surface of the roll of tape;
biasing alignment fingers built into the device that exert a pressure against the roll of tape in a direction substantially parallel to the spindle and substantially perpendicular to the direction of the pressure of the retention fingers;
a base surface comprising an opening through which an end of the roll of tape can be inserted, the base surface comprising a wear surface over which the tape moves in response to pressure on the base surface; and
a cutting edge coupled to the base surface.

9. The device of claim 8 wherein each of the plurality of retention fingers comprises a detent at the end of the finger.

10. The device of claim 8 wherein the biasing alignment fingers are comprised of depressions in the surface of the device that exert an active spring pressure against the roll of tape to align an edge of the tape with an outer edge of the device.

11. The device of claim 8 wherein the wear surface is a non-moving surface.

12. The device of claim 8 wherein the wear surface is a rotating surface.

13. The device of claim 12 wherein the rotating surface rotates in response to pressure on the base surface.

14. The device of claim 8 wherein the cutting edge is coupled to a flat applicator surface and is substantially adjacent to and pointing away from the opening.

15. The device of claim 8 and further including a flat applicator surface between the opening and the cutting edge over which the tape moves as it is being applied from the opening.

16. The device of claim 8 and further including a brush on the base surface.

17. The device of claim 16 wherein the brush is positioned to burnish the tape on an application surface.

18. The device of claim 16 wherein the brush is positioned to clean an application surface prior to application of the tape.

19. The device of claim 8 and further including a cleaning element on the base surface for cleaning an application surface prior to application of the tape.

20. A tape system comprising:
a roll of tape comprising an inner surface and an outer surface; and
a housing into which the roll of tape is positioned, the housing comprising:
a plurality of biasing alignment fingers arranged in a circular pattern that exert a spring pressure against the roll of tape to align an edge of the outer surface of the roll of tape with an outer edge of the housing;
a spindle having an outer surface to accept the inner surface of the tape roll, the outer surface having a plurality of retention fingers that exert a retention pressure against the inner surface of the roll of tape, the retention pressure substantially perpendicular to the spring pressure; and
a base surface comprising an opening, a wear surface, a flat applicator surface and a cutting edge such that the tape exits the housing through the opening and moves around the wear surface and along the applicator surface in response to pressure exerted on the tape on the applicator surface.

21. The system of claim 20 and further including a handle formed in the inside of the spindle.

22. The system of claim 20 wherein the wear surface is a cylindrical, movable surface that rotates in response to pressure on the applicator surface and the wear surface.

23. The system of claim 20 wherein the housing further comprises depressions on opposing sides.

24. A method for manufacturing a tape applicator, the method comprising:
forming a housing for the tape;
forming a spindle in the housing, the spindle comprising a plurality of retention fingers that extend outward from the spindle;
forming biasing alignment fingers that extend inward from the surface of the housing such that the biasing alignment fingers are capable of applying spring pressure to the tape;
forming an opening in a base of the housing that permits the tape to exit the housing;
forming a wear surface substantially adjacent to the opening; and
coupling a cutting edge to the base such that a flat applicator surface is formed between the cutting edge and the opening.

25. A tape applicator device comprising:
a spindle adapted to accept a roll of tape, the spindle comprising a plurality of retention fingers substantially equally spaced around the outer periphery of the spindle such that they apply pressure to the inner surface of the roll of tape;
a metal device coupled to an inside surface of the spindle such that the metal device applies a force to the plurality of retention fingers;
biasing alignment fingers built into the device that exert a pressure against the roll of tape in a direction substantially parallel to the spindle and substantially perpendicular to the direction of the pressure of the retention fingers;
a base surface comprising an opening through which an end of the roll of tape can be inserted, the base surface comprising a wear surface over which the tape moves in response to pressure on the base surface; and
a cutting edge coupled to the base surface.

26. A tape system comprising:
a roll of tape wound on a spool comprising an inner surface, the inner surface having at least one detent; and
a housing into which the roll of tape is inserted, the housing comprising:
a plurality of biasing alignment fingers arranged in a circular pattern that exert a spring pressure against the roll of tape to align an edge of an outer surface of the roll of tape with an outer edge of the housing;
a spindle having an outer surface to accept the spool, the outer surface having a plurality of retention fingers that are adapted to fit into the at least one detent; and
a base surface comprising an opening, a wear surface, a flat applicator surface and a cutting edge such that the tape exits the housing through the opening and moves around the wear surface and along the applicator surface in response to pressure exerted on the tape on the applicator surface.

27. The system of claim 26 wherein the at least one detent is a groove that encircles the inside perimeter of the spool such that ends of the plurality of retention fingers are adapted to be inserted into the groove when the spool is accepted by the spindle.

28. The system of claim 26 wherein the at least one detent comprise a plurality of detents that are located in a predetermined orientation that substantially matches an orientation of the retention fingers such that an end of each retention finger is adapted to be inserted in a respective detent when the spool is accepted by the spindle.
